(19) United States
(12) Patent Application Publication
(10) Pub. No.: US 2026/0252247 A1
(43) Pub. Date: Aug. 27, 2026

(54) NVM CONFIGURATION WITH BINARY CONFIGURATION FILE

(71) Applicant: Micron Technology, Inc., Boise, ID (US)

(72) Inventor: Marco Redaelli, Munchen (DE)

(21) Appl. No.: 19/543,270

(22) Filed: Feb. 18, 2026

Related U.S. Application Data
(60) Provisional application No. 63/762,988, filed on Feb. 25, 2025.

(51) Int. Cl. G06F 3/06

(52) U.S. Cl. CPC G06F 3/0632; G06F 3/0614; G06F 3/0679

(57) ABSTRACT

The number of possible solid state drive (SSD) configurations is increasing as non-volatile memory (NVM) technology advances. Configuration may further be complicated by the use of special operating systems, such as hypervisors, for device programming, a need to boot the host with virtual machines, and the like. As a result, automating factor configuration by mass programming devices in parallel is frequently unsuccessful. As discussed herein, a first device is programmed using a series of configuration commands. The configuration data for the successfully configured device is exported to a binary file. Additional devices are configured using a single configuration command along with the data from the binary file. Configuration of the additional devices can be verified by exporting the configuration data for the additional devices and comparing the result with the binary file received from the first device.

### PRIORITY APPLICATION

This application claims the benefit of priority to U.S. Provisional Application Ser. No. 63/762,988, filed Feb. 25, 2025, which is incorporated herein by reference in its entirety.

### TECHNICAL FIELD

The present disclosure generally relates to configuration of non-volatile memory (NVM) systems.

### BACKGROUND

A memory device can be a storage device, such as a solid-state drive (SSD), and can include one or more memory components that store data. The memory components can be, for example, NVM components and volatile memory components. In general, a host system can use a memory device to store data at the memory components and to retrieve data from the memory components.

NAND memory cells may store a single bit per cell or multiple bits per cell. For example, triple-level cell (TLC) memory stores three bits per cell. The data may be stored by storing one of eight levels of charge in the cell. The eight voltage levels of a TLC may be referred to as L0-L7, with L0 having the lowest threshold voltage and L7 having the highest threshold voltage.

Configuring the memory cells of a NAND as single-level cells (SLC) that store one bit per cell improves reliability compared with a TLC configuration. However, a TLC configuration allows for a larger amount of data storage using the same hardware. Accordingly, hardware may be configured differently for different purposes.

To configure an NVM device, a series of commands are sent to the device. The commands may enable or disable ports, determine whether memory cells are used as TLC cells or SLC cells, and the like. Configuration may require restarting the NVM device one or more times.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory device, in accordance with some embodiments of the present disclosure.

FIG. 2 is a swim lane diagram that shows communications among a host, a first memory device, and a second memory device, in accordance with some embodiments of the present disclosure.

FIG. 3 shows an example of binary data for a configuration command, in accordance with some embodiments of the present disclosure.

FIG. 4 is a flow diagram of an example method for replicating configuration of memory devices, in accordance with some embodiments of the present disclosure.

FIG. 5 is a block diagram of an example computer system in which embodiments of the present disclosure may operate.

### DETAILED DESCRIPTION

Aspects of the present disclosure are directed to NVM configuration using a binary configuration file. An SSD is one example of an NVM device. The number of possible SSD configurations is increasing as NVM technology advances. For example, a single device may be configurable to use TLC or SLC memory cells, to operate in a user mode or a protected mode, to operate at one of several available clock speeds, to operate at one of several available operating voltages, to use different ports, to use different namespaces, or any suitable combination thereof.

Configuring an SSD involves several steps. Initially, the number of ports is configured. Following this, capacity management operations are performed, such as the set up of NVM sets and endurance groups. Peripheral Component Interconnect Express (PCIe) virtual functions (VFs) may be configured according to Peripheral Component Interconnect-Special Interest Group (PCI-SIG) specifications. For example, a NumVFs (number of VFs) register and a VF Enable bit of a Single Root Input/Output Virtualization (SR-IOV) control register may be set.

After VFs are configured and enabled, an NVMe virtualization management command may be used to set a number of queues and interrupts for a NVM express (NVMe) secondary controller. The queues and interrupts are configured for each VF. The configuration of the NVM device may be saved for error recovery and other vendor-specific operations, such as arbitration. Private or shared namespaces may be created and attached to the primary or secondary controller. The drive may be prepared for production programming using additional steps. Furthermore, security features such as Trusted Computing Group (TCG) Opal may also be set up.

Configuration may further be complicated by the use of special operating systems, such as hypervisors, for device programming, a need to boot the host with virtual machines, and the like. As a result, automating factor configuration by mass programming devices in parallel is frequently unsuccessful.

As discussed herein, a first memory device, such as a SSD device comprising non-volatile memory cells, is programmed using a series of configuration commands. The configuration data for the successfully configured device is exported to a binary file. Additional devices are configured using a single configuration command along with the data from the binary file.

Configuration of the additional devices can be verified by exporting the configuration data for the additional devices and comparing the result with the binary file received from the first device. Alternatively, the binary file received from the first device may be provided to the additional devices a second time and the additional devices may themselves verify that the configuration is correct. The memory devices may support binary download and upload commands using a Firmware Download command, rather than relying on complex vendor-specific SET/GET feature commands.

As a result, the complexity involved in configuring the additional devices is substantially reduced and the reliability of the configuration is improved. The traditional configuration process requires significant resources, including specialized pre-programmers and skilled personnel. By automating the configuration process through the creation and deployment of binary configuration files, the methods disclosed herein reduce the need for extensive manual intervention and specialized equipment, reducing costs and resources.

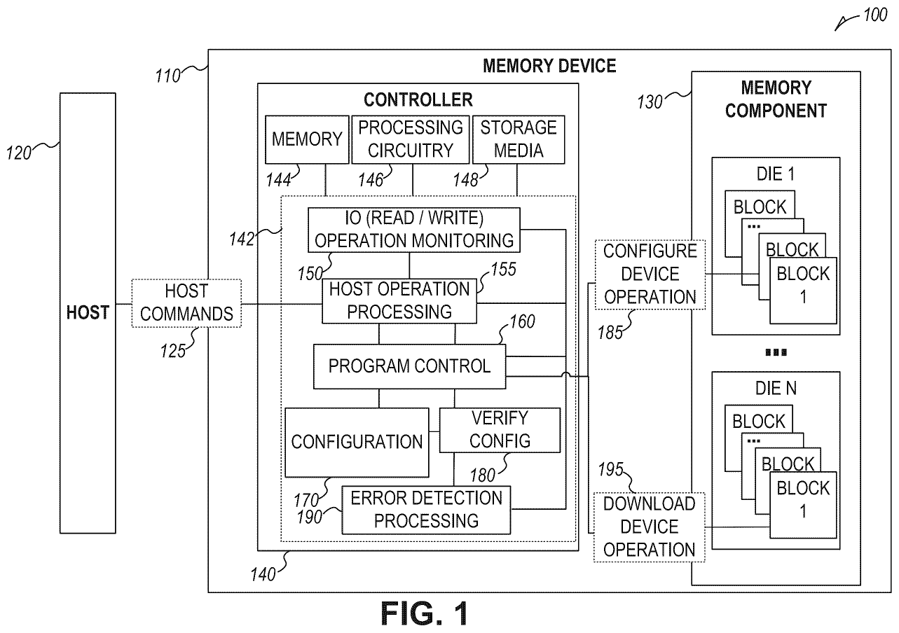

FIG. 1 provides a block diagram of an example system 100 including a memory device 110 (e.g., a SSD storage device, a secure digital (SD) card, a multimedia card (MMC), etc.) having a memory controller 140 and a memory component 130. In an example, the functionality of control modules 142 of the memory controller 140 may be implemented in respective modules in a firmware of the memory controller 140. However, it will be understood that various forms of software, firmware, and hardware may be used by the memory controller 140 to implement the control modules 142 (e.g., implement the functionality of program control 160) and the other techniques discussed herein.

As shown, the memory device 110 includes a memory component 130 with multiple dies (dies 1-N), with each die including one or more blocks (blocks 1-N), and each of the one or more blocks comprises multiple memory cells. Each of the one or more blocks may include further divided portions, such as one or more wordlines (not shown) per block; and each of the one or more wordlines may be further comprised of one or more pages (not shown) per wordline, depending on the number of data states that the memory cells of that wordline are configured to store.

Accessing data from the memory component 130 may comprise applying a read voltage to a wordline, wherein the voltage applied to the wordline is different than the signaling voltage used to indicate that the voltage should be applied. A voltage level shifter may be used to convert the signaling voltage in a first power domain to the read voltage in a second power domain.

In an example, the blocks of memory cells of the memory component 130 include groups of at least one of: single-level cell (SLC), multi-layer cell (MLC), TLC, or quad-layer cell (QLC) NAND memory cells. Also, in an example, the memory component 130 is arranged into a stack of three-dimensional (3D) NAND dies. These configurations and further detailed components of the memory component 130 are not illustrated in FIG. 1 for simplicity. However, the memory component 130 may incorporate these or any of the features described above with reference to features of 3D NAND architecture devices or other forms of NAND storage devices.

In 3D architecture semiconductor memory technology, vertical structures are stacked, increasing the number of tiers and physical pages, and accordingly, the density of a memory device (e.g., a storage device). In an example, the memory device 110 can be a discrete memory or storage device component of the host device 120. In other examples, the memory device 110 can be a portion of an integrated circuit (e.g., system on a chip (SOC), etc.), stacked or otherwise included with one or more other components of the host device 120.

Each flash memory cell in a NAND architecture semiconductor memory array may be programmed to two or more programmed states. For example, an SLC may represent one of two programmed states (e.g., 1 or 0), representing one bit of data. Flash memory cells may also represent more than two programmed states, allowing the manufacture of higher density memories without increasing the number of memory cells, as each cell may represent more than one binary digit (e.g., more than one bit). Such cells may be referred to as multi-state memory cells, multi-digit cells, or MLCs. In certain examples, MLC may refer to a memory cell that may store two bits of data per cell (e.g., one of four programmed states), TLC may refer to a memory cell that may store three bits of data per cell (e.g., one of eight programmed states), and a QLC may store four bits of data per cell. MLC is used herein in its broader context, to refer to any memory cell(s) that may store more than one bit of data per cell (i.e., that may represent more than two programmed states; thus, the term MLC is used herein in the broader context, to be generic to memory cells storing 2, 3, 4, or more bits of data per cell).

The memory device 110 is shown as being operably coupled to a host device 120 via a memory controller 140 of the memory device. The memory controller 140 is adapted to receive and process host input/output (IO) commands 125, such as read commands, write commands, erase commands, and the like, to read, write, erase, and manage data stored within the memory component 130. In other examples, the memory controller 140 may be physically separate from an individual memory device and may receive and process commands for one or more individual memory devices. A variety of other components for the memory device 110 (such as a memory manager, and other circuitry or operational components) and the memory controller 140 are also not depicted for simplicity.

The memory controller 140 is depicted as including a memory 144 (e.g., volatile memory), processing circuitry 146 (e.g., a microprocessor), and a storage media 148 (e.g., non-volatile memory), used for executing instructions (e.g., instructions hosted by the storage media 148, loaded into memory 144, and executed by the processing circuitry 146) to implement the control modules 142 for management and use of the memory component 130. The functionality provided by the control modules 142 may include, but is not limited to: IO operation monitoring 150 (e.g., to monitor read and write IO operations, originating from host commands); host operation processing 155 (e.g., to interpret and process the host IO commands 125, and to issue further commands to the memory component 130 to perform respective read, write, erase, or other host-initiated operations); program control 160 (e.g., to control the timing, criteria, conditions, and parameters of respective memory program operations on the memory component 130); configuration control 170 (e.g., to control a configure device operation 185 to configure ports, namespaces, operating parameters, and the like of the memory component 130); verify configuration 180 (e.g., to verify that the memory component 130 has been correctly configured by the configuration control 170); and error detection processing 190 (e.g., to identify and correct errors from data obtained in read operations, to identify one or more raw bit error rates (RBER[s]) for a particular read operation or set of operations, etc.).

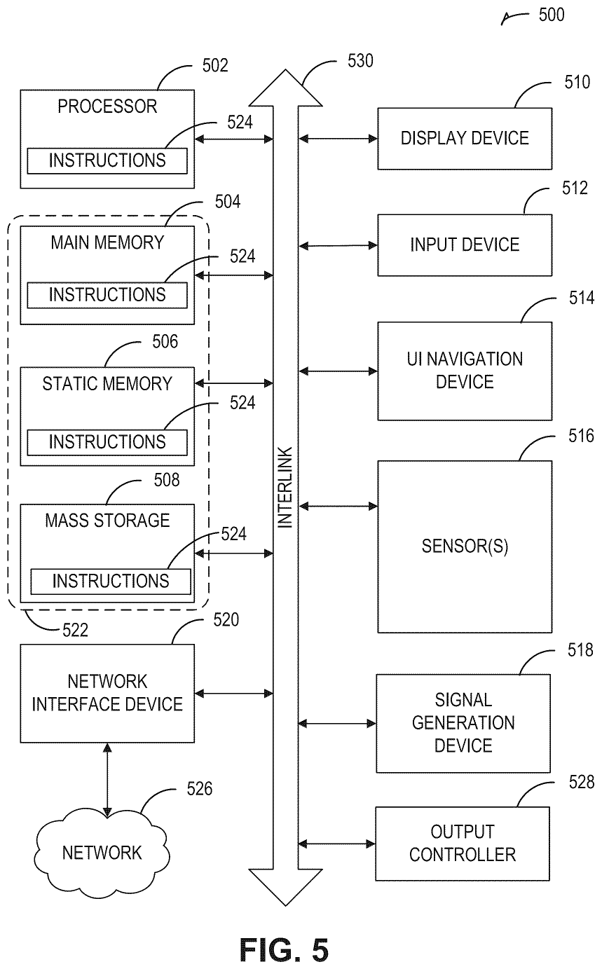

One or more communication interfaces can be used to transfer the host IO commands 125 between the memory device 110 and one or more other components of the host device 120, such as a Serial Advanced Technology Attachment (SATA) interface, a Peripheral Component Interconnect Express (PCIe) interface, a Universal Serial Bus (USB) interface, a Universal Flash Storage (UFS) interface, an eMMC™ interface, or one or more other connectors or interfaces. The host device 120 can include a host system, an electronic device, a processor, a memory card reader, or one or more other electronic devices external to the memory device 110. In some examples, the host device 120 may be a machine having some portion, or all, of the components discussed in reference to the computer system 500 of FIG. 5.

In an example, the host operation processing 155 is used to interpret and process the host IO commands 125 (e.g., read and write commands) and initiate accompanying commands in the memory controller 140 and the memory component 130 to accomplish the host IO commands 125. Further, the host operation processing 155 may coordinate timing, conditions, and parameters of the program control 160 in response to the host IO commands 125, IO operation monitoring 150, and error detection processing 190.

The IO operation monitoring 150 operates, in some example embodiments, to track reads and writes to the memory component 130 initiated by host IO commands. The IO operation monitoring 150 also operates to track accompanying IO operations and states, such as a host IO active or inactive state (e.g., where an active state corresponds to the state of the memory controller 140 and memory component 130 actively performing read or write IO operations initiated from the host device 120, and where an inactive state corresponds to an absence of performing such IO operations initiated from the host device 120). The IO operation monitoring 150 may also monitor voltage level and read error rates occurring with the IO operations initiated from the host device 120, in connection with determining parameters for the program control 160 as discussed herein.

The program control 160 can include, among other things, circuitry or components (hardware and/or software) configured to control memory operations associated with writing data to, reading data from, or erasing one or more memory cells of the memory component 130 coupled to the memory controller 140. The program control 160 further operates to initiate and perform memory program operations based on host IO commands 125 or internal operations from the memory controller 140.

A read voltage control, in some example embodiments, is used to establish, change, and provide a voltage value used to read a particular area of memory (such as a respective block in the memory component 130). For example, the read voltage control may implement various positive or negative offsets in order to read respective memory cells and memory locations (e.g., pages, blocks, dies) including the respective memory cells. A voltage level shifter may be used to transition control signals from a first power domain to control signals in a second power domain. The operating voltage of the second power domain may be controlled by the read voltage control. For example, a common ground may be used in the two power domains, a fixed voltage source used as the operating voltage of the first power domain, and the output of a voltage source, configured by the read voltage control, used as the operating voltage of the second power domain.

In an example, a verify calibration is used to establish (e.g., change, update, reset, etc.) whether or not a verify operation should be performed after a program operation. The verify calibration may be implemented based on a number or percentage of bits in the memory component 130 that were successfully programmed at a lower voltage level.

The error detection processing 190, in some example embodiments, may detect a recoverable error condition (e.g., a RBER value or an RBER trend), an unrecoverable error condition, or other measurements or error conditions for a memory cell, a group of cells, or larger areas of the memory array (e.g., averages or samples from a block, group of blocks, die, group of dies, etc.).

Additionally, the sampling and read operations that are performed in a read scan by the program control 160 may allow configuration, such as from a specification (e.g., a determined setting or calculation) of: a size of data (e.g., data corresponding to a page, block, group of blocks, die) that is programmed; a number of pages in total that are programmed; a number of pages within a block that are programmed; whether certain cells, pages, blocks, dies, or certain types of such cells, pages, blocks, dies are or are not programmed; and the like. Likewise, the program control 160 may control or allow configuration of the number of program cycles that are performed before the first verify cycle, the number of program cycles that are performed between verify cycles, the number of bits to be successfully programmed at each level before next-level verification begins, or any suitable combination thereof.

In addition to the techniques discussed herein, other types of maintenance operations may be implemented by the control modules 142 in the memory controller 140. Such operations may include garbage collection or reclamation, wear leveling, block management, and other forms of background activities performed upon the memory component 130. Such background activities may be triggered during an idle state detected by the IO operation monitoring 150, such as immediately following or concurrent with a read scan operation.

The program control 160 can include an error correction code (ECC) component, which can include, among other things, an ECC engine or other circuitry configured to detect or correct errors associated with writing data to or reading data from one or more memory cells of the memory component 130 coupled to the memory controller 140. The memory controller 140 can be configured to actively detect and recover from error occurrences (e.g., bit errors, operation errors, etc.) associated with various operations or storage of data, while maintaining integrity of the data transferred between the host device 120 and the memory device 110, or maintaining integrity of stored data (e.g., using redundant array of inexpensive disks [RAID] storage, etc.), and can retire failing memory resources (e.g., memory cells, memory arrays, pages, blocks, etc.) to prevent future errors.

The configuration control 170 may perform a series of configure device operations 185 on the memory component 130. After configuration is complete, a download device operation 195 is performed, causing the controller 140 to receive configuration data for the memory component 130 in a binary format. The binary configuration data is provided to the host device 120. The host device 120 is connected to another memory device 110 and the binary configuration data is used in a single configure device operation 185 to configure the other memory device 110. The verify configuration 180 may use the download device operation 195 and compare the binary configuration data of the second memory device 110 with the binary configuration data provided by the host device 120 to confirm that the configuration data match. In the event of a mismatch, the configure device operation 185 may be repeated or an error code may be returned to the host device 120.

Using the systems and methods discussed herein, identical configuration of multiple memory devices is facilitated. As a result, time and effort, as well as processor and memory cycles, are saved in performing a task of configuring multiple memory devices.

The memory component 130 can include several memory cells arranged in, for example, a number of devices, planes, sub-blocks, blocks, or pages. As one example, a 48 GB TLC NAND memory device can include 18,592 bytes (B) of data per page (16,384+2208 bytes), 1536 pages per block, 548 blocks per plane, and 4 or more planes per device. As another example, a 32 GB MLC memory device (storing two bits of data per cell (i.e., 4 programmable states)) can include 18,592 bytes (B) of data per page (16,384+2208 bytes), 1024 pages per block, 548 blocks per plane, and 4 planes per device, but with half the required write time and twice the program/erase (P/E) cycles as a corresponding TLC memory device. Other examples can include other numbers or arrangements. In some examples, a memory device, or a portion thereof, may be selectively operated in SLC mode, or in a desired MLC mode (such as TLC, QLC, etc.).

In operation, data is typically written to or read from the memory device 110 in pages and erased in blocks. However, one or more memory operations (e.g., read, write, erase, etc.) can be performed on larger or smaller groups of memory cells, as desired. The data transfer size of a NAND memory device is typically referred to as a page, whereas the data transfer size of a host is typically referred to as a sector.

Although a page of data can include a number of bytes of user data (e.g., a data payload including a number of sectors of data) and its corresponding metadata, the size of the page often refers only to the number of bytes used to store the user data. As an example, a page of data having a page size of 4 KB may include 4 KB of user data (e.g., 8 sectors assuming a sector size of 512 B) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory components 130 can provide for different page sizes, or may require different amounts of metadata associated therewith. For example, different memory device types may have different bit error rates, which can lead to different amounts of metadata necessary to ensure integrity of the page of data (e.g., a memory device with a higher bit error rate may require more bytes of error correction code data than a memory device with a lower bit error rate). As an example, a MLC NAND flash device may have a higher bit error rate than a corresponding SLC NAND flash device. As such, the MLC device may require more metadata bytes for error data than the corresponding SLC device.

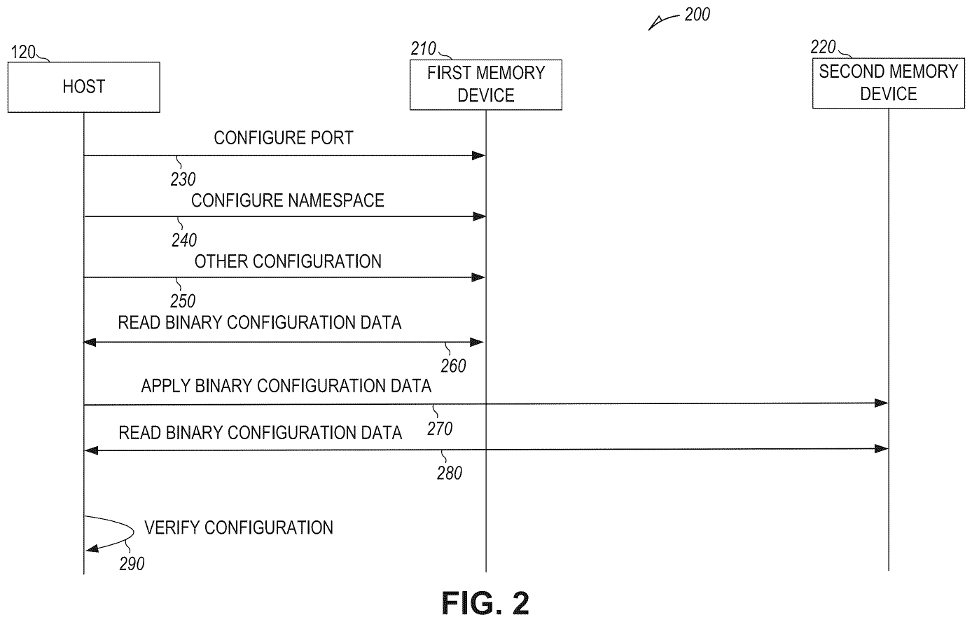

FIG. 2 is a swim lane diagram 200 that shows communications among the host device 120, a first memory device 210, and a second memory device 220, in accordance with some embodiments of the present disclosure.

The host device 120 sends a series of configuration commands 230, 240, 250 to the first memory device 210. The configuration command 230 configures one or more ports of the first memory device 210. The configuration command 240 configures one or more namespaces of the first memory device 210. The configuration command 250 performs other configuration of the first memory device 210, such as defining operating voltages, selecting between SLC and TLC, setting an available address range, and the like.

After configuration of the first memory device 210 is complete, the host device 120 reads binary configuration data from the first memory device 210 in communication 260. Thereafter, a second memory device 220 is configured by applying the binary configuration data from the first memory device 210. At communication 270 the binary configuration data can be provided to the second memory device 220 from the host device 120 or from the first memory device 210. The binary configuration data includes values for the series of configuration commands provided to the first memory device 210. In an example, the second memory device 220 can process or load the binary configuration data using a single command. After processing of the single command and using the received binary configuration data following communication 270, the second memory device 220 should be configured identically to the first memory device 210.

To verify that the two memory devices 210, 220 are identically configured, the host device 120, in communication 280, reads the binary configuration data from the second memory device 210. For example, the host device 120 may send a read binary configuration data command to the second memory device 220. The second memory device 220 responds to the read binary configuration data command with the binary configuration data. In operation 290, the binary configuration data read from the first memory device 210 is compared to the binary configuration data read from the second memory device 220. If the configuration data for the two devices match, then the second memory device 220 has been correctly configured. Otherwise, communications 270-280 and operation 290 are repeated. If the second memory device 220 repeatedly fails to be correctly configured, this may indicate a defective part which may be discarded and replaced. Communications 270-280 and operation 290 may be repeated with any number of additional memory devices, allowing for efficient identical configuration of multiple memory devices.

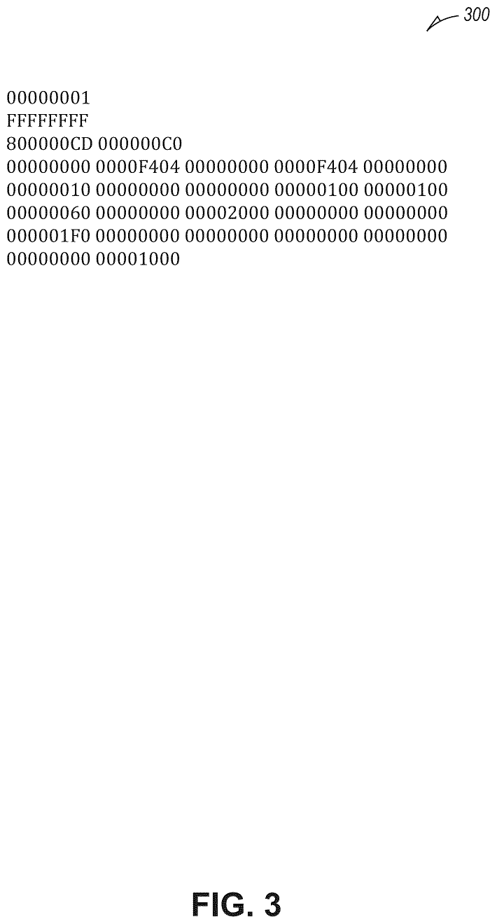

FIG. 3 shows an example of binary data for a configuration command, in accordance with some embodiments of the present disclosure. The binary data is shown in hexadecimal notation, with two characters for each byte. The first four bytes comprise a header that indicates a version number of the binary data. A memory device may support multiple versions and, based on the version number, determine a format of the binary data. Alternatively, a memory device may support only a single version. In either case, if an unsupported version is received, the memory device may return an error code instead of processing the remaining binary data.

The binary data 300 of FIG. 3 may be received from a configured memory device, sent as part of a configuration command to an unconfigured memory device, or both. For example, a first memory device may be configured using the series of commands below. A hexadecimal value is indicated by prefixing the value with 0x.
nvme delete-ns/dev/nvme0-n 0xFFFFFFFF
nvme admin-passthru/dev/nvme0-opcode=0x09-cdw10=0x800000CD=cdw1=0x000000C0
nvme subsystem-reset/dev/nvme0
# wait for reset to complete, then
echo “00000000 00 00 F4 04 00 00 00 00 00 00 F4 04 00 00 00 00”
   |xxd-r-data. bin # create/overwrite
echo “00000010 00 00 00 00 00 00 00 00 00 00 01 00 00 00 01 00”
   |xxd-r-data. bin # append
echo “00000060 00 00 00 00 00 00 20 00 00 00 00 00 00 00 00 00”
   |xxd-r-data. bin # append
echo “0 0 0 0 0 1F0 00 00 00 00 00 00 00 00 00 00 00 00 00 00 00 00”
   |xxd-r-data. bin # append
hexdump-C./data.bin
nvme admin-passthru/dev/nvme0-opcode=0x0D-cdw10=0x0-data-len=4096 -w-input-file=data. bin-s

In the example above, the first memory device is addressed as/dev/nvme0. Host commands are sent to the first memory device to delete existing namespaces, and to perform specific operation codes 0x09 and 0x0D, with specified arguments. After configuration of the first device, a command may be issued to the device to generate binary data for the configuration. In the examples below, 0xNEW_OPCODE1 is a new opcode for reading binary configuration data from a memory device; 0xNEW_OPCODE2 is a new opcode for writing binary configuration data to a memory device.
nvme admin-passthru/dev/nvme0-opcode=0xNEW_OPCODE1 data-len=4096-r—output-file=config.bin

A second device may be configured using the generated binary data: nvme admin-passthru/dev/nvme1-opcode=0xNEW_OPCODE2 data-len=4096-w—input-file=data.bin

In this example, the value 0xFFFFFFFF is an argument to the delete-ns command. The following two values are arguments to the admin-passthru command with opcode=0x09. The remaining values are for the admin-passthru command with opcode=0x0D. Thus, by providing the second device with the binary data 300, the second memory device may execute identical internal configuration commands without repeatedly interacting with the host. Additionally, once created, the binary data 300 may be provided to multiple memory devices and used by each of the devices for configuration.

In various example embodiments, different configuration operations are performed by the second memory device based on the binary data. Example operations include: deleting an existing namespace, configuring a namespace by setting a size of the namespace, configuring a port using a plurality of parameters determined from the binary data, configuring a namespace using a plurality of parameters determined from the binary data, configuring at least a portion of the memory cells to operate in a TLC mode, and configuring at least a portion of the memory cells to operate in an SLC mode. For example, a different versions of binary configuration data, as indicated by the first four bytes of the binary data 300, may cause different configuration operations to be performed.

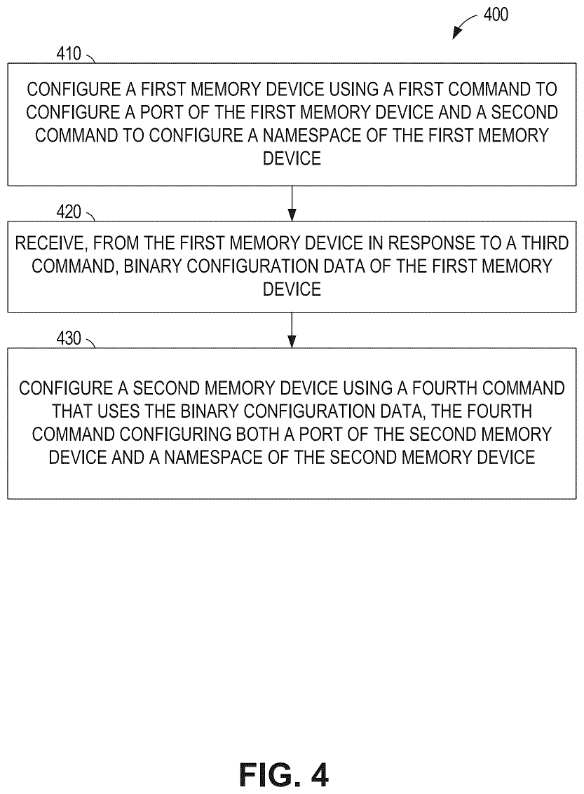

FIG. 4 is a flow diagram of an example method 400 for replicating configuration of memory devices, in accordance with some embodiments of the present disclosure. The method 400 includes operations 410, 420, and 430. By way of example and not limitation, the method 400 is described as being performed by the host device 120 in conjunction with the memory controller 140 and the memory component 130, all of FIG. 1.

In operation 410, the host device 120 configures a first memory device using a first command to configure a port of the first memory device and a second command to configure a namespace of the first memory device. For example, two NVMe commands may be sent, as host IO commands 125, from the host device 120 to the memory device 110. In response to the commands, the controller 140 updates settings stored in the storage media 148, performs configure device operations 185, or any suitable combination thereof. Configuration of a namespace is important for NVMe devices, since the namespace identifies the logical blocks that are addressable by host software. In various example embodiments, more or fewer configuration commands may be performed in operation 410.

The host device 120, in operation 420, receives from the first memory device in response to a third command, binary configuration data of the first memory device. For example, the third command may be an NVMe command to download the binary configuration data. Example binary configuration data is shown in FIG. 3.

In operation 430, the host device 120 configures a second memory device using a fourth command that uses the binary configuration data. The fourth command configures both a port of the second memory device and a namespace of the second memory device. In some example embodiments, a single NVMe command takes the binary configuration data as a parameter. The controller 140 of the second memory device uses the binary configuration data to perform the same configuration that was performed by the first memory device in response to the multiple commands of operation 410.

Thus, by use of the method 400, only the first memory device is configured using multiple commands. Any number of additional memory devices are configured using a single command, based on binary configuration data retrieved from the first memory device. As a result, the process of configuring multiple devices is simplified and made less error-prone.

The configuration of the second memory device can be verified by the host device. The host device sends a command to the second memory device to provide binary configuration data (e.g., by repeating operation 420 for the second memory device instead of the first memory device). The binary configuration data received from the second memory device is compared to the binary configuration data received from the first memory device. If the configurations match, the second memory device has been correctly configured.

Alternatively, another command may be sent to the second memory device to perform self-verification. In the example below, 0xNEW_OPCODE3 represents a new opcode for this verification operation. The second memory device accesses its configuration values as if it were generating a binary configuration file and compares the accessed values with the input binary configuration data. If all values match, a success code is returned. If any values differ, an error code is returned.
nvme admin-passthru/dev/nvme1-opcode=0xNEW_OPCODE3 data-len=4096-w—input-file=data.bin

If a mismatch in configuration is detected by the second memory device or the host, operation 430 may be repeated or the second memory device may be flagged as defective. The binary configuration data of the two devices may represent a port configuration, a namespace configuration, additional configuration data, or any suitable combination thereof.

In view of the disclosure above, various examples are set forth below. It should be noted that one or more features of an example, taken in isolation or combination, should be considered within the disclosure of this application.

Example 1 is a memory device comprising: a memory component comprising a plurality of blocks, wherein each block of the plurality of blocks comprises multiple memory cells; and a processing device programmed to perform operations comprising: receiving a command from a host device, the command comprising binary data, the binary data comprising configuration information from a reference memory device; and based on the binary data, configuring one or more operational parameters of the memory component.

In Example 2, the subject matter of Example 1, wherein the configuring of the one or more operational parameters of the memory component comprises configuring a port of the memory component and configuring a namespace of the memory component.

In Example 3, the subject matter of Examples 1-2, wherein the configuring of the one or more operational parameters of the memory component comprises configuring a memory cell mode of the memory component and configuring an operating voltage of the memory component.

In Example 4, the subject matter of Examples 1-3, wherein the command is a non-volatile memory express (NVMe) command.

In Example 5, the subject matter of Examples 1-4, wherein the binary data comprises a header that identifies a format of the binary data.

In Example 6, the subject matter of Examples 1-5, wherein the operations further comprise: based on the binary data, deleting an existing namespace of the memory component.

In Example 7, the subject matter of Examples 1-6, wherein the configuring of the one or more operational parameters of the memory component comprises setting a size of a namespace of the memory component.

In Example 8, the subject matter of Examples 1-7, wherein the configuring of the one or more operational parameters of the memory component comprises determining, from the binary data, a plurality of parameters for a port configuration operation.

In Example 9, the subject matter of Examples 1-8, wherein the configuring of the one or more operational parameters of the memory component comprises determining, from the binary data, a plurality of parameters for a namespace configuration operation.

In Example 10, the subject matter of Examples 1-9, wherein the operations further comprise: in response to receiving a second command from the host device, generating output binary data that represents a configuration of a port of the memory component and a configuration of a namespace of the memory component.

In Example 11, the subject matter of Examples 1-10, wherein the operations further comprise: based on the binary data, configuring at least a portion of the memory cells of the memory component to operate in a triple-level cell (TLC) mode.

In Example 12, the subject matter of Examples 1-11, wherein the operations further comprise: based on the binary data, configuring at least a portion of the memory cells of the memory component to operate in a single-level cell (SLC) mode.

In Example 13, the subject matter of Examples 1-12, wherein the memory component comprises a non-volatile memory (NVM).

In Example 14, the subject matter of Example 13, wherein the NVM comprises one or more of an embedded MultiMediaCard (eMMC), a Universal Flash Storage (UFS), and a Secure Digital (SD) card.

In Example 15, the subject matter of Examples 1-14, wherein the memory component comprises a solid-state drive (SSD).

Example 16 is a method comprising: receiving, from a first memory device in response to a first command, binary configuration data of the first memory device; and configuring a second memory device using a second command that uses the binary configuration data, the second command configuring one or more operational parameters of a memory component of the second memory device.

In Example 17, the subject matter of Example 16 includes configuring the first memory device using a third command that deletes a namespace of the first memory device, wherein the second command configures the second memory device by deleting a namespace of the second memory device.

In Example 18, the subject matter of Examples 16-17 includes configuring a namespace of the first memory device by setting a size of the namespace of the first memory device, wherein the second command configures the second memory device by setting a size of the namespace of the second memory device.

Example 19 is a non-transitory computer-readable storage medium comprising instructions that, when executed by a processing device, cause the processing device to perform operations comprising: receiving, from a first memory device in response to a first command, binary configuration data of the first memory device; and configuring a second memory device using a second command that uses the binary configuration data, the second command configuring one or more operational parameters of a memory component of the second memory device.

In Example 20, the subject matter of Example 19, wherein the operations further comprise: receiving, from the second memory device in response to a third command, binary configuration data of the second memory device; and verifying that the second memory device was correctly configured by comparing the binary configuration data of the second memory device with the binary configuration data of the first memory device.

Example 21 is an apparatus comprising means to implement any of Examples 1-20.

FIG. 5 is a block diagram of an example computer system 500 in which embodiments of the present disclosure may operate. In some embodiments, the computer system 500 corresponds to a host system that includes, is coupled to, or uses a memory system or a memory device (e.g., the memory device 110 of FIG. 1) or can be used to perform the operations of a controller (e.g., the memory controller 140 of FIG. 1). The instructions 524 may include, for example, instructions 524 and/or logic described herein. In alternative embodiments, the computer system 500 can be connected (e.g., networked) to other computers in a local area network (LAN), an intranet, an extranet, and/or the Internet. The computer system 500 can operate in the capacity of a server or a client computer in client-server network environment, as a peer computer in a peer-to-peer (or distributed) network environment, or as a server or a client computer in a cloud computing infrastructure or environment.

The computer system 500 can be a personal computer (PC), a tablet PC, a set-top box (STB), a Personal Digital Assistant (PDA), a cellular telephone, a web appliance, a server, a network router, a switch or bridge, or any computer capable of executing a set of instructions (sequential or otherwise) that specify actions to be taken by that computer. Further, while a single computer system is illustrated, the term “computer system” shall also be taken to include any collection of computer systems that individually or jointly execute a set (or multiple sets) of instructions to perform any one or more of the methodologies discussed herein.

Circuitry (e.g., processing circuitry) is a collection of circuits implemented in tangible entities of the computer system 500 that include hardware (e.g., simple circuits, gates, logic, etc.). Circuitry membership can be flexible over time. Circuitries include members that can, alone or in combination, perform specified operations when operating. In an example, hardware of the circuitry can be immutably designed to carry out a specific operation (e.g., hardwired). In an example, the hardware of the circuitry can include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the computer-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

In alternative embodiments, the computer system 500 can operate as a standalone device or can be connected (e.g., networked) to other computer systems. In a networked deployment, the computer system 500 can operate in the capacity of a server computer system, a client computer system, or both in server-client network environments. In an example, the computer system 500 can act as a peer computer system in a peer-to-peer (P2P) (or other distributed) network environment.

The computer system 500 can include a hardware processor 502 (e.g., a central processing unit (CPU), a graphics processing unit (GPU), a hardware processor core, or any combination thereof), a main memory 504, a static memory 506 (e.g., memory or storage for firmware, microcode, a basic-input-output (BIOS), unified extensible firmware interface (UEFI), etc.), and mass storage device 508 (e.g., hard drives, tape drives, flash storage, or other block devices) some or all of which can communicate with each other via an interlink 530 (e.g., bus). The computer system 500 can further include a display device 510, an alphanumeric input device 512 (e.g., a keyboard), and a user interface (UI) navigation device 514 (e.g., a mouse). In an example, the display device 510, the input device 512, and the UI navigation device 514 can be a touch screen display. The computer system 500 can additionally include a signal generation device 518 (e.g., a speaker), a network interface device 520, and one or more sensor(s) 516, such as a global positioning system (GPS) sensor, compass, accelerometer, or other sensor. The computer system 500 can include an output controller 528, such as a serial (e.g., USB, parallel, or other wired or wireless (e.g., infrared (IR), near field communication (NFC), etc.) connection to communicate or control one or more peripheral devices (e.g., a printer, card reader, etc.).

Registers of the hardware processor 502, the main memory 504, the static memory 506, or the mass storage device 508 can be, or include, a computer-readable media 522 on which is stored one or more sets of data structures or instructions 524 (e.g., software) embodying or used by any one or more of the techniques or functions described herein. The instructions 524 can also reside, completely or at least partially, within any of registers of the hardware processor 502, the main memory 504, the static memory 506, or the mass storage device 508 during execution thereof by the computer system 500. In an example, one or any combination of the hardware processor 502, the main memory 504, the static memory 506, or the mass storage device 508 can constitute the computer-readable media 522. While the computer-readable media 522 is illustrated as a single medium, the term “computer-readable medium” can include a single medium or multiple media (e.g., a centralized or distributed database, or associated caches and servers) configured to store the one or more instructions 524.

The term “computer-readable medium” can include any medium that is capable of storing, encoding, or carrying instructions for execution by the computer system 500 and that cause the computer system 500 to perform any one or more of the techniques of the present disclosure, or that is capable of storing, encoding, or carrying data structures used by or associated with such instructions. Non-limiting computer-readable medium examples can include solid-state memories, optical media, magnetic media, and signals (e.g., radio frequency signals, other photon-based signals, sound signals, etc.). In an example, a non-transitory computer-readable medium comprises a computer-readable medium with a plurality of particles having invariant (e.g., rest) mass, and thus are compositions of matter. Accordingly, non-transitory computer-readable media are computer-readable media that do not include transitory propagating signals. Specific examples of non-transitory computer-readable media can include: non-volatile memory, such as semiconductor memory sub-systems (e.g., electrically programmable read-only memory (EPROM), electrically erasable programmable read-only memory [EEPROM]) and flash memory sub-systems; magnetic disks, such as internal hard disks and removable disks; magneto-optical disks; and CD-ROM and DVD-ROM disks.

In an example, information stored or otherwise provided on the computer-readable media 522 can be representative of the instructions 524, such as instructions 524 themselves or a format from which the instructions 524 can be derived. This format from which the instructions 524 can be derived can include source code, encoded instructions (e.g., in compressed or encrypted form), packaged instructions (e.g., split into multiple packages), or the like. The information representative of the instructions 524 in the computer-readable media 522 can be processed by processing circuitry into the instructions to implement any of the operations discussed herein. For example, deriving the instructions 524 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 524.

In an example, the derivation of the instructions 524 can include assembly, compilation, or interpretation of the information (e.g., by the processing circuitry) to create the instructions 524 from some intermediate or preprocessed format provided by the computer-readable media 522. The information, when provided in multiple parts, can be combined, unpacked, and modified to create the instructions 524. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, compiled, or interpreted (e.g., into a library, stand-alone executable etc.) at a local computer, and executed by the local computer.

The instructions 524 can be further transmitted or received over a communications network 526 using a transmission medium via the network interface device 520 using any one of a number of transfer protocols (e.g., frame relay, internet protocol, transmission control protocol (TCP), user datagram protocol (UDP), hypertext transfer protocol (HTTP), etc.). Example communication networks can include a LAN, a wide area network (WAN), a packet dataC network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.16.4 family of standards, P2P networks, among others. In an example, the network interface device 520 can include one or more physical jacks (e.g., Ethernet, coaxial, or phone jacks) or one or more antennas to connect to the network 526. In an example, the network interface device 520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the computer system 500, and includes digital or analog communications signals or other intangible medium to facilitate communication of such software. A transmission medium is a computer-readable medium.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

In the foregoing specification, embodiments of the disclosure have been described with reference to specific example embodiments thereof. It will be evident that various modifications can be made thereto without departing from the scope of embodiments of the disclosure as set forth in the following claims. The specification and drawings are, accordingly, to be regarded in an illustrative sense rather than a restrictive sense.

What is claimed is:

1. A memory device comprising:
a memory component comprising a plurality of blocks, wherein each block of the plurality of blocks comprises multiple memory cells; and
a processing device programmed to perform operations comprising:
receiving a command from a host device, the command comprising binary data, the binary data comprising configuration information from a reference memory device; and
based on the binary data, configuring one or more operational parameters of the memory component.

2. The memory device of claim 1, wherein the configuring of the one or more operational parameters of the memory component comprises configuring a port of the memory component and configuring a namespace of the memory component.

3. The memory device of claim 1, wherein the configuring of the one or more operational parameters of the memory component comprises configuring a memory cell mode of the memory component and configuring an operating voltage of the memory component.

4. The memory device of claim 1, wherein the command is a non-volatile memory express (NVMe) command.

5. The memory device of claim 1, wherein the binary data comprises a header that identifies a format of the binary data.

6. The memory device of claim 1, wherein the operations further comprise:
based on the binary data, deleting an existing namespace of the memory component.

7. The memory device of claim 1, wherein the configuring of the one or more operational parameters of the memory component comprises setting a size of a namespace of the memory component.

8. The memory device of claim 1, wherein the configuring of the one or more operational parameters of the memory component comprises determining, from the binary data, a plurality of parameters for a port configuration operation.

9. The memory device of claim 1, wherein the configuring of the one or more operational parameters of the memory component comprises determining, from the binary data, a plurality of parameters for a namespace configuration operation.

10. The memory device of claim 1, wherein the operations further comprise:
in response to receiving a second command from the host device, generating output binary data that represents a configuration of a port of the memory component and a configuration of a namespace of the memory component.

11. The memory device of claim 1, wherein the operations further comprise:
based on the binary data, configuring at least a portion of the memory cells of the memory component to operate in a triple-level cell (TLC) mode.

12. The memory device of claim 1, wherein the operations further comprise:
based on the binary data, configuring at least a portion of the memory cells of the memory component to operate in a single-level cell (SLC) mode.

13. The memory device of claim 1, wherein the memory component comprises a non-volatile memory (NVM).

14. The memory device of claim 13, wherein the NVM comprises one or more of an embedded MultiMediaCard (eMMC), a Universal Flash Storage (UFS), and a Secure Digital (SD) card.

15. The memory device of claim 1, wherein the memory component comprises a solid-state drive (SSD).

16. A method comprising:
receiving, from a first memory device in response to a first command, binary configuration data of the first memory device; and
configuring a second memory device using a second command that uses the binary configuration data, the second command configuring one or more operational parameters of a memory component of the second memory device.

17. The method of claim 16, further comprising configuring the first memory device using a third command that deletes a namespace of the first memory device, wherein the second command configures the second memory device by deleting a namespace of the second memory device.

18. The method of claim 16, further comprising configuring a namespace of the first memory device by setting a size of the namespace of the first memory device, wherein the second command configures the second memory device by setting a size of the namespace of the second memory device.

19. A non-transitory computer-readable storage medium comprising instructions that, when executed by a processing device, cause the processing device to perform operations comprising:
receiving, from a first memory device in response to a first command, binary configuration data of the first memory device; and
configuring a second memory device using a second command that uses the binary configuration data, the second command configuring one or more operational parameters of a memory component of the second memory device.

20. The non-transitory computer-readable storage medium of claim 19, wherein the operations further comprise:
receiving, from the second memory device in response to a third command, binary configuration data of the second memory device; and
verifying that the second memory device was correctly configured by comparing the binary configuration data of the second memory device with the binary configuration data of the first memory device.
